(19) United States
(12) Patent Application Publication
(10) Pub. No.: US 2010/0250295 A1
(43) Pub. Date: Sep. 30, 2010

(54) SOA LIFECYCLE GOVERNANCE AND MANAGEMENT

(75) Inventors: Kishore Channabasavaiah, Palatine, IL (US); Sri Ramanathan, Lutz, FL (US); Matthew B. Trevathan, Kennesaw, GA (US); Raghu Varadan, San Francisco, CA (US); Nevenko Zunic, Hopewell Junction, NY (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/410,497

(22) Filed: Mar. 25, 2009

(51) Int. Cl. G06Q 10/00

(52) U.S. Cl. 705/7

(57) ABSTRACT

Methods, including service methods, articles of manufacture, systems, articles and programmable devices are provided for implementing a service-oriented architecture governance framework. A programmable device configured by a logic component identifies a gap within a service-oriented architecture service orientation enterprise of concern as a function of a service-oriented architecture governance dimension. The service-oriented architecture governance dimension may be a service-oriented architecture business and information technology alignment dimension, a service-oriented architecture ownership and decision rights dimension, a service-oriented architecture asset lifecycle enablement and management dimension or a service-oriented architecture operational management and monitoring dimension. Some methods also identify and select a process within a service-oriented architecture governance dimension applicable to an identified enterprise of concern, apply the selected process against a stage of a service-oriented architecture business service lifecycle management component of the enterprise of concern, and customize and enable a change management process and capability corresponding to the enterprise of concern.

### FIELD OF THE INVENTION

The present invention generally describes methods, systems and devices for creating and integrating service-oriented architecture governance with existing governance processes.

### BACKGROUND OF THE INVENTION

Changing business needs over time may result in the creation of complex, inflexible application architectures, often with high levels of redundancy of business functions and data. To ensure that business needs drive information technology (IT) solutions many organizations desire to break down application “silos”, wherein the deployment of multiple IT systems such as enterprise resource planning (ERP), customer relationship management (CRM), data warehouses, customer portals and content management systems results in incomplete and inconsistent pictures of corporate information and project or group-specific business functions. More particularly, it is desired to increase focus on building IT integration capabilities to develop and deploy shareable and reusable services that may be used across lines of business and across processes in a manner dictated by business needs and not by the application or information technology (IT) architecture.

Organizations are increasingly turning to service-oriented architecture (SOA) methods, systems and governance models to develop and deploy shareable and reusable services. Governance is the underlying foundation of organizational transformation and managing an enterprise around its various initiatives. A well-defined governance model that enables a transformation defines the outcome of the initiatives undertaken by the enterprise. The defined governance model impacts the processes and entities that come under the purview of the transformation and, in addition, may impact others that play no role in the immediate transformation.

An SOA governance model provides a framework that enables an organization to come to a consensus on the scope of SOA governance and its definition and use. Current SOA Governance models fail to extend themselves to managing service orientation aspects of business to IT strategies, instead starting with addressing downstream aspects of business to IT planning and transformation stages through focusing on service strategy. Current models also fail to reflect governance of change management capabilities across every aspect of service orientation. Though they may address organizational change management across traditional and non-SOA lifecycle models, these approaches are insufficient for the adoption of service orientation through SOA across an entire enterprise.

### SUMMARY OF THE INVENTION

Methods are provided for implementing a service-oriented architecture governance framework. A programmable device configured by a logic component identifies a gap within a service-oriented architecture service orientation enterprise of concern as a function of a service-oriented architecture governance dimension. The service-oriented architecture governance dimension may be a service-oriented architecture business and information technology alignment dimension, a service-oriented architecture ownership and decision rights dimension, a service-oriented architecture asset lifecycle enablement and management dimension or a service-oriented architecture operational management and monitoring dimension. Some methods also identify and select a process within a service-oriented architecture governance dimension applicable to an identified enterprise of concern, apply the selected process against a stage of a service-oriented architecture business service lifecycle management component of the enterprise of concern, and customize and enable a change management process and capability corresponding to the enterprise of concern.

Service methods are also provided comprising deploying programmable devices or logic components or applications for implementing a service-oriented architecture governance framework according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for implementing a service-oriented architecture governance framework. Moreover, systems, articles and programmable devices are also provided, configured for performing one or more method and/or process elements of the current invention for implementing a service-oriented architecture governance framework, for example as described above.

### BRIEF DESCRIPTION OF THE DRAWINGS

These and other features of the methods, systems and devices according to the present application will be more readily understood from the following detailed description of the various aspects of the embodiments taken in conjunction with the accompanying drawings in which:

FIG. 1 is a flow chart illustrating governing SOA across an enterprises' lifecycle according to the present invention.

FIG. 2 is diagrammatic illustration of an SOA Governance Framework according to the present invention.

FIG. 3 is diagrammatic illustration of a method or process for implementing an SOA governance framework according to the present invention.

FIG. 4 is a block diagram of a system or device configured to implement an SOA governance framework according to the present invention.

FIG. 5 is a block diagram illustrating a computerized implementation of a method or system for an SOA governance framework according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description; and

II. Computerized Implementation.

### I. General Description

It is desirable to conduct a thorough review of all processes and entities that are within an organizational transformation domain or at its periphery to ensure that they have been considered in a governance model definition. The impacted processes include those within both the business and IT domains, and neither should be ignored in defining the governance model nor should one be considered less significant than the other. Moreover, participation of stakeholders and key decision makers in the definition of a governance model is advantageous to the overall success of an organizational transformation.

SOA governance impacts an entire organization involved in a transformation and generally requires participation by several stakeholders in its definition and realization. A defined governance framework and an underlying model helps drive effective change across the enterprise. A well-defined governance framework is a key to success irrespective of the entry point chosen by an enterprise for SOA transformation. The SOA governance model is generally realized by establishing a governance body and comprises domain owners and stakeholders with delegated responsibility for decision making.

Examples of SOA aspects and governance processes according to the present invention may be found in the following commonly-owned and co-pending U.S. patent applications or issued U.S. patents, the disclosures of which are expressly incorporated herein by reference: “Identifying a Service Oriented Architecture Shared Services Project”, attorney docket no. END920080252US1, filed on (to be provided), and assigned application serial no. (to be provided); “Evaluating a Service Oriented Architecture Shared Services Project”, attorney docket no. END920080288US1, filed on (to be provided), and assigned application serial no. (to be provided); “Service Oriented Architecture Shared Service Inception”, attorney docket no. END920080289US1, filed on (to be provided), and assigned application serial no. (to be provided); “Service Oriented Architecture Shared Services Elaboration”, attorney docket no. END920080290US1, filed on (to be provided), and assigned application serial no. (to be provided); “Service Oriented Architecture Shared Services Construction”, attorney docket no. END920080291US1, filed on (to be provided), and assigned application serial no. (to be provided); “Transitioning to Management of a Service Oriented Architecture Shared Service”, attorney docket no. END920080292US1, filed on (to be provided), and assigned application serial no. (to be provided); “Service Oriented Architecture Shared Service Management”, attorney docket no. END920080293US1, filed on (to be provided), and assigned application serial no. (to be provided); “Service Oriented Architecture Shared Service Escalation”, attorney docket no. END920080294US1, filed on (to be provided), and was assigned application serial no. (to be provided); “SOA POLICY VERSIONING”, attorney docket no. END920080316US1-IEN106616, filed on (to be provided), and assigned application serial no. (to be provided); “FRAMEWORK FOR VARIATION ORIENTED ANALYSIS FOR SERVICE-ORIENTED ARCHITECTURE”, attorney docket no. END920080317US1-IEN106617, filed on (to be provided), and assigned application serial no. (to be provided); “TECHNICAL FEASIBILITY EXPLORATION FOR SERVICE-ORIENTED ARCHITECTURE ENVIRONMENTS”, attorney docket no. END920080318US1-IEN106618, filed on (to be provided), and assigned application serial no. (to be provided); “ENABLING SOA GOVERNANCE USING A SERVICE LIFECYCLE APPROACH”, attorney docket no. END920080320US1-IEN106620, filed on (to be provided), and assigned application serial no. (to be provided); “CALIBRATION FRAMEWORK FOR EFFORT ESTIMATION”, attorney docket no. END920080321US1-IEN106621, filed on (to be provided), and assigned application serial no. (to be provided); “SERVICE PORTFOLIO APPROACH FOR SOA GOVERNANCE”, attorney docket no. END920080386US1-IEN106642, filed on (to be provided), and assigned application serial no. (to be provided); “SERVICE EVOLUTION APPROACH IN SOA”, attorney docket no. END920080387US1-IEN106643, filed on (to be provided), and assigned application serial no. (to be provided); “CAPABILITY AND MATURITY-BASED SOA GOVERNANCE”, attorney docket no. END920080388US1-IEN106644, filed on (to be provided), and assigned application serial no. (to be provided); “PRIORITIZATION ENABLEMENT FOR SOA GOVERNANCE”, attorney docket no. END920080389US1-IEN106645, filed on (to be provided), and assigned application serial no. (to be provided); and “SOA POLICY ENGINE FRAMEWORK”, attorney docket no. END920080390US1-IEN106646, filed on (to be provided), and assigned application serial no. (to be provided).

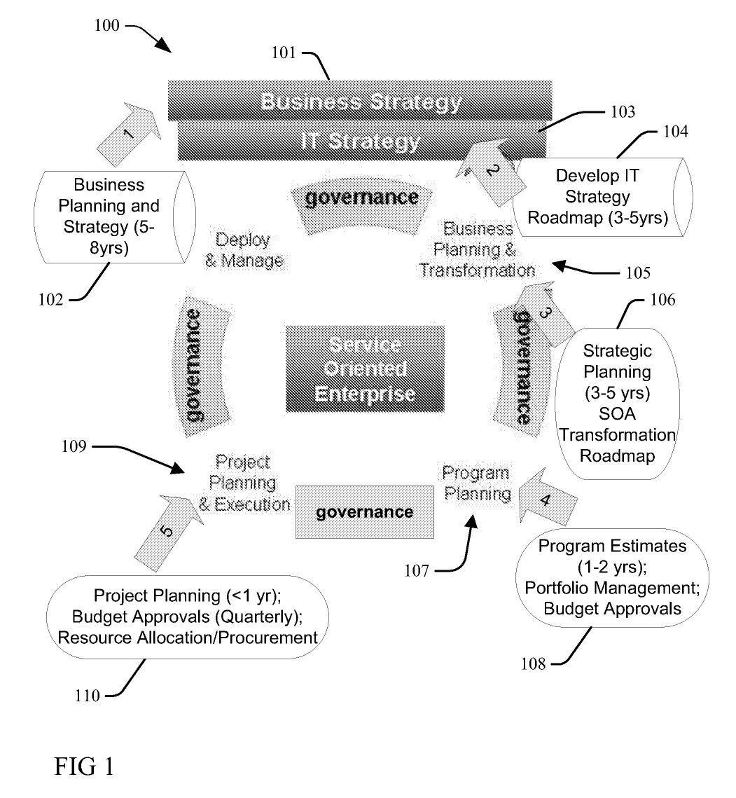

FIG. 1 illustrates an SOA Lifescycle Management Model 100 providing a method or system for governing SOA across an enterprises' lifecycle according to the present invention. As organizations introduce an SOA shared services method and processes, it is essential to build around an end-to-end framework that supports business aspects of service orientation. As depicted in FIG. 1, effective proliferation of SOA is dependent upon reflecting aspects of SOA Governance in stage 1 Business Planning and Strategy (5-8 years) 102 within Business Strategy 101 and stage 2 Develop IT Strategy Roadmap (3-5 years) 104 within IT Strategy 103. FIG. 1 also depicts introducing stage 3 Strategic Planning (3-5 yrs) and SOA Transformation Roadmap 106 into Business Planning & Transformation 105; stage 4 Program Estimates (1-2 yrs), Portfolio Management and Budget Approvals 108 into Program Planning 107; and stage 5 Project Planning (<1 yr), Budget Approvals (Quarterly) and Resource Allocation/Procurement 110 into Project Planning & Execution 109.

Current SOA Governance models fail to extend themselves to managing Service Orientation aspects of Business to IT Strategies. They start with addressing downstream aspects of Business to IT planning and Transformation stages through a focus on Service Strategy. Current models also do not reflect Governance of Change Management capabilities across every single aspect of Service Orientation. They may address Organizational Change Management across traditional and non-SOA lifecycle models, which is not sufficient to make this paradigm shift required for adoption of Service Orientation through SOA across the enterprise.

Implementation of current SOA Governance models are also driven based on SOA lifecycle, but these lifecycle models continue to be traditional approaches as they lack the organizational collaborative aspects introduced by the SOA entities. In addition, enterprises undergo constant changes in the marketplace and also grow by way of acquisitions as one of the many examples. In such a scenario, the extended enterprise may be at a different level of adoption and maturity. This necessitates the need for a SOA Governance framework focusing on the key aspects of adoption Service Orientation which lends itself to flexibility and not just a lifecycle-based SOA Governance model.

SOA governance according to the present invention is a specialization that extends IT governance and focuses on effectively managing the lifecycle of a service, handling key decisions around IT and the business aspects of the service life cycle. This framework allows for creating and integrating SOA Governance with existing governance processes and takes SOA enablement to an end-to-end level across an enterprise.

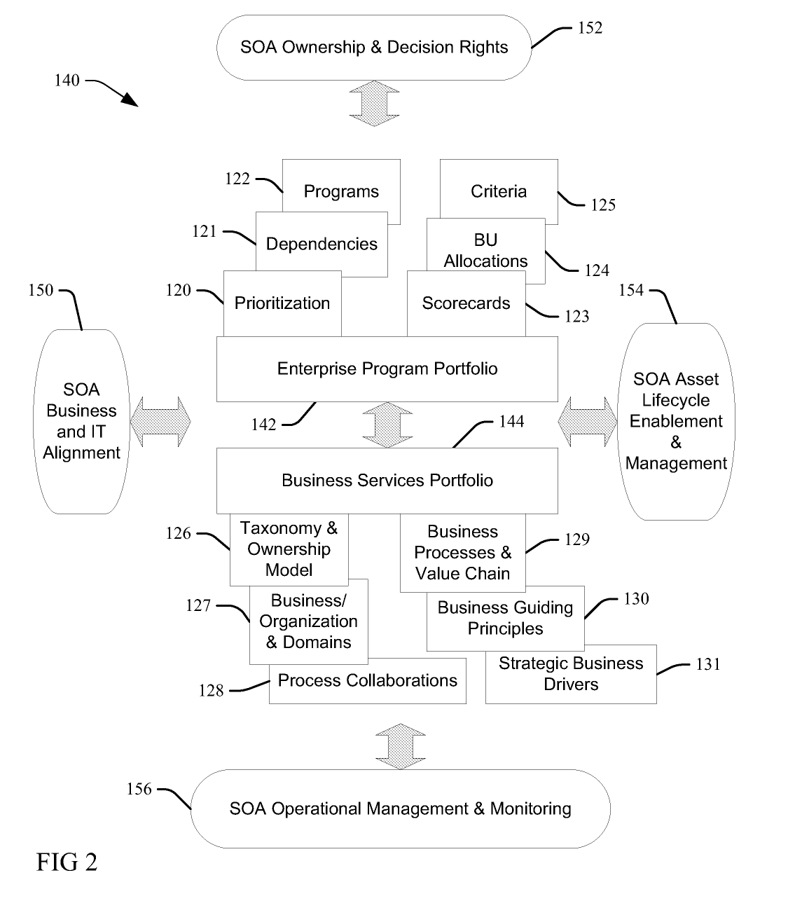

FIG. 2 illustrates an SOA Governance Framework 140 according to the present invention. The SOA Governance Framework 140 identifies four major dimensions or aspects 150, 152, 154 and 156 of SOA Governance which are centered around an Enterprise Business Portfolio 142 and a Business Services Portfolio 144. The Enterprise Business Portfolio 142 comprises Prioritization 120, Dependencies 121, Programs 122, Scorecards 123, BU Allocations 124 and Criteria 125, as well as other elements as may be apparent to one skilled in the art. The Business Services Portfolio 144 comprises a Taxonomy & Ownership Model 126, Business/Organizations Domains 127, Process Collaborations 128, Business Processes & Value Chain 129, Business Guiding Principles 130, and Strategic Business Drivers 131, as well as other elements as may be apparent to one skilled in the art.

The portfolio-centric governance framework 140 allows for proliferation and management of SOA from both business and IT aspects. The present framework 140 is not only about governing but emphasizes the proliferation of services using a portfolio approach. The framework 140 provides the four different aspects 150, 152, 154 and 156 and is all-encompassing from an SOA enablement point-of-view, further allowing for definition of SOA governance processes/mechanisms to allow effective proliferation of SOA across an enterprise.

The governance framework 140 allows different parts of the organization or newer capabilities of the organization to engage at any point-in-time, or with different levels of maturity and adoption of SOA. For example, acquisitions may be at some adoption point and maturity level. According to the present invention, there is no reason to reset them to conform to an inflexible governance model.

Change management is a common element across all of the four different aspects 150, 152, 154 and 156 of SOA Governance. In contrast, current models are generally focused only on organizational change management. Additionally, the present invention enables the introduction of change at any step in the process/methodology of the comprehensive framework 140 rather than at some fixed or defined point.

In another aspect, the framework 140 revolves around the proliferation of services through the Business Services Portfolio 144 and its integration with the Enterprise Program Portfolio 142. The SOA Governance framework 140 allows enterprises to continue to perform business, and adopt SOA Governance processes and mechanisms as needed to only specific parts of the enterprise. The governance framework 140 is Business Services Portfolio 144 centric and hence lends itself to business aspects, and is not narrowed down to lifecycle-based implementation methods which tend to focus primarily on IT aspects.

The SOA Business and IT Alignment dimension 150 may be considered a fundamental tenet of SOA and one that significantly influences the overall governance model. Prioritization of services during early business planning stages and identifying suitable SOA-based transformation initiatives during this planning activity drives business and IT alignment. According to the present invention, the participation and role of IT teams in early business planning activities, ongoing validation of the SOA transformation, and the realization of initiatives by the business teams should be defined and documented in the governance framework/model 140. In addition, the participation of business and IT teams in these initiatives should span the entire services life cycle, which can span multiple cycles of maturity and realization of the organization's SOA vision.

The SOA Ownership & Decision Rights dimension 152 model is a key component of SOA governance according to the present invention. The decision rights that provide guidance on the roles, responsibilities, and rights are generally integral to the overall ownership model itself. Service realization prioritization is an integral component of the ownership model 152 and is generally driven by a defined process that accommodates conflicting requirements from different consuming entities: in one embodiment an executive oversight committee with representation on an organizational governance body is part of the ownership model 152 realization. The ownership model 152 also provides for representation by both providers and known consumers; newer consumers may also be represented as the framework 140 ecosystem grows. The ownership model 152 includes additional attributes: for example, authority for change and process, the rights for definition, and the realization of service level agreements (SLA's) between providers and consumers. In addition, the process and rights for data ownership across the service portfolio 142 is an integral component of the ownership model 152, and a funding model (including the definition of budgetary contributions by parties providing and consuming a service) is also part of the governance ownership model 152. In some instances, funding for a given service may need to be made available by a requestor of a service and in other instances it may be made available as an organizational allocation. Irrespective of the levels of contribution, the responsibility for each such contribution should generally be defined at the outset of the framework 140.

With respect to the SOA Asset Lifecycle Enablement and Management dimension 154, creation and reuse is one of the key value drivers for SOA transformation for any enterprise and may manifest itself in many different forms and at various stages of realization. Service proliferation is a major inhibitor to realizing value in any SOA transformation initiative and needs to be managed as part of the overall governance model. Definition of processes and identifying the metrics and measures to prevent service proliferation is an integral activity for the development of an SOA governance model. In addition, an asset management framework with a focus on driving reuse across the enterprise is one of the key components of the SOA governance model. Sustaining high quality and providing the framework required to significantly enhance the speed of delivery of services are also considerations of the asset life-cycle component 154 of the overall governance model 140. In one aspect, change management process and the rights and decisions associated with changes are integral to the overall asset enablement life cycle 154.

The SOA Operational Management and Monitoring dimension 156 encompasses cost effectiveness and business benefits as two key metrics an enterprise would use to measure the value of an organizational change initiative. According to the present invention, the metrics are defined during an initial business planning phase and measured at various stages during an actual transformation cycle. The SOA governance framework 140 also includes attributes for the definition and management of these metrics, as well as those for processes, roles, and rights. Service operational management and monitoring attributes, including effectiveness, utilization, life-cycle costs, overall project costs, and the resulting tangible and intangible business benefits, are also defined and measured as part of implementing an SOA governance model 140 according to the present invention.

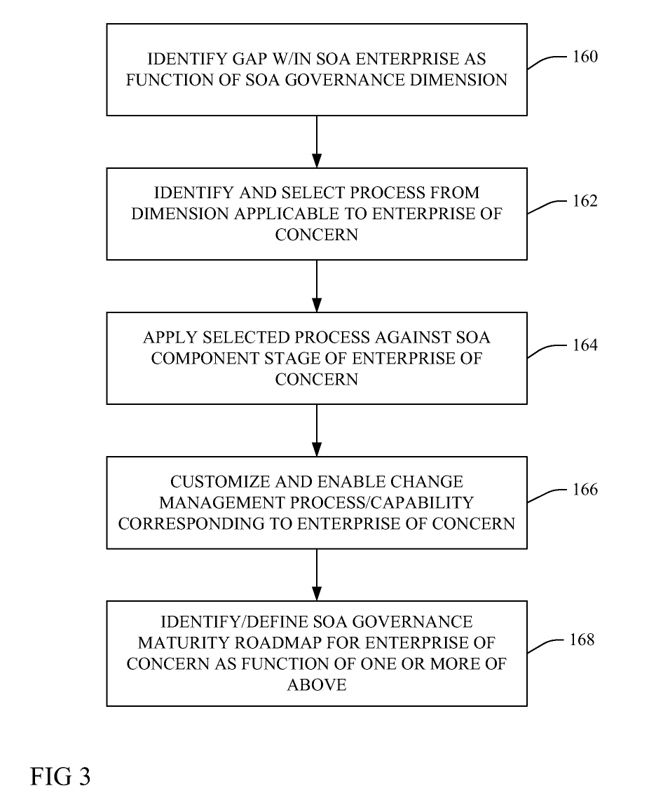

FIG. 3 illustrates a method and process for implementing the SOA governance framework 140 according to the present invention. The framework 140 can be applied using a variety of governance enablement techniques that enable the following governance enablement aspects. At 160 gaps are identified within an enterprise for SOA service orientation (the enterprise of concern) as a function of at least one of the SOA Business and IT alignment 150, the SOA Ownership & Decision Rights 152, the SOA Asset lifecycle enablement and management 154 and the SOA Operational Management and Monitoring 156 aspects/dimensions.

At 162 one or more processes/mechanisms within the dimensions 150/152/154/156 applicable to the identified enterprise of concern are identified and selected. At 164 the selected process(es) are applied against one or more various stages of an SOA business service lifecycle management component of the enterprise of concern (e.g. one of the stages 102, 104, 106 108 and 110 of FIG. 1).

At 166 change management processes and capabilities corresponding to the enterprise of concern are customized and enabled, in one aspect for seamless functioning of new SOA Governance capabilities introduced by the framework 140. Lastly, at 168 a SOA governance maturity roadmap is identified or defined for the enterprise of concern as a function of at least one of the identifying the gap at 160, the identifying/selecting the enterprise of concern at 162, the applying the selected process(es) against the stage(s) of the SOA business service lifecycle management component at 164 and the customizing/enabling of change management process(es)/capability(ies) at 166.

Illustrative but not exhaustive examples of SOA Business and IT alignment aspect 150 processes that may be identified and applied at 162 include Enterprise Program Portfolio 142 & Business Services Portfolio 144 alignment, business services discovery, program & services prioritization, business case & planning, business process collaborations, business services identification, business & IT change management and business services policy strategy & definition processes, and others may be apparent to one skilled in the art.

Illustrative but not exhaustive examples of SOA Ownership & Decision Rights dimension 152 processes that may be identified and applied at 162 include business services ownership, business services funding, domain classification & taxonomies, business services ownership change management, business services stakeholder management and business services policy ownership & stakeholder assignment processes, and others may be apparent to one skilled in the art.

Illustrative but not exhaustive examples of SOA Asset Lifecycle Enablement and Management dimension 154 processes that may be identified and applied at 162 include service discovery & publishing, asset discovery & publishing, asset lifecycle change management, business services asset reuse management, business services & SOA standards, business services asset reuse programs, asset repositories & registries and business services policy registry processes, and others may be apparent to one skilled in the art.

Illustrative but not exhaustive examples of SOA Service Operational Management and Monitoring 156 processes that may be identified and applied at 162 include business services utilization & metering, business services performance monitoring, operational service change management, services provisioning, business services metrics measurement, services testing and certification, business services version management and business services policy enforcement & monitoring compliance processes, and others may be apparent to one skilled in the art.

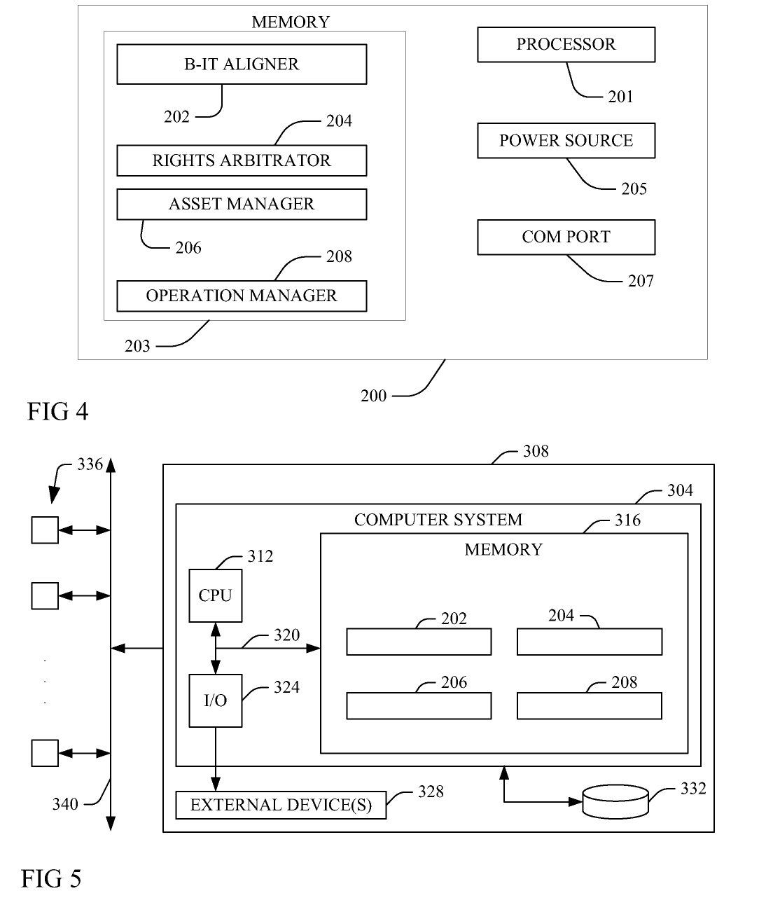

FIG. 4 illustrates a programmable device or module 200 configured to implement an SOA governance framework according to the present invention, for example as illustrated in FIGS. 1-3 and described above. The device 200 may be incorporated into a larger system (such as one provided by a service provider) wherein other applications and components of the larger system accomplish systems and methods according to the present invention, or it may be a stand-alone device or module 200 configured to perform each of the systems and methods described above. The present embodiment comprises a central processing unit (CPU) or other processing means 201 in communication with a memory 203 comprising logic components that enable the CPU 201 to perform processes and methods according to the present application, as will be understood through reference to FIGS. 1-3 as discussed above. Thus, the memory 203 comprises a B-IT Aligner logic component (e.g. algorithm, etc.) 202 configured to perform functions and services of the SOA Business and IT Alignment dimension 150; a Rights Arbitrator logic component 204 configured to perform functions and services of the SOA Ownership & Decision Rights dimension 152; an Asset Manager logic component 206 configured to perform functions and services of the SOA Asset Lifecycle Enablement and Management dimension 154; and an Operation Manager logic component 208 configured to perform functions and services of the SOA Operational Management and Monitoring dimension 156. However, it will be understood that in other embodiments one or more of the components 202, 204, 206 and 208 may be omitted, and its functions or algorithms combined with others of the components 202, 204, 206 and 208 or accomplished by other systems, components, elements or parties.

A power source 205 is configured to provide operative power to the device 200; examples include battery units 205 and power inputs configured to receive alternating or direct current electrical power, and other appropriate power units 205 will be apparent to one skilled in the art. A communication port or network link/node means (“com port”) 207 is also provided and configured to enable data and other communications as may be appropriate, for example as discussed above.

### II. Computerized Implementation

Referring now to FIG. 5, an exemplary computerized implementation of the present invention includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage systems 332. In general, the processing unit 312 executes computer program code, such as the code to implement various components of the process and systems, and devices as illustrated in FIGS. 1-4 and described above, including the SOA Business and IT Alignment dimension logic component 202, the SOA Ownership & Decision Rights dimension logic component 204, the SOA Asset Lifecycle Enablement and Management dimension logic component 206 and the SOA Operational Management and Monitoring dimension logic component 208, and which are stored in memory 316 and/or storage system 332. It is to be appreciated that two or more, including all, of these components may be implemented as a single component.

While executing computer program code, the processing unit 312 can read and/or write data to/from the memory 316, the storage system 332 (e.g. the, and/or the I/O interfaces 324. The bus 320 provides a communication link between each of the components in computer system 304. The external devices 328 can comprise any devices (e.g., keyboards, pointing devices, displays, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 5 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement methods, systems and devices according to the present application, for example as illustrated in FIGS. 1-4 above and described otherwise herein. To this extent, the computer-readable/useable medium includes program code that implements each of the various process steps of the present application.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation according to the present application could be deployed, managed, serviced, etc. by a service provider who offers to implement, deploy, and/or perform the functions of the present invention for others, for example by licensing methods and browser or application server technology to an internet service provider (ISP) or a cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the present application for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the processes, methods and devices according to the present application. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 304, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Certain examples and elements described in the present specification, including in the claims and as illustrated in the Figures, may be distinguished or otherwise identified from others by unique adjectives (e.g. a “first” element distinguished from another “second” or “third” of a plurality of elements, a “primary” distinguished from a “secondary,” an “another”, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for implementing a service-oriented architecture governance framework, comprising:
providing a programmable device configured by a logic component;
the programmable device identifying a gap within a service-oriented architecture service orientation enterprise of concern as a function of:
a service-oriented architecture business and information technology alignment governance dimension;
a service-oriented architecture ownership and decision rights governance dimension;
a service-oriented architecture asset lifecycle enablement and management governance dimension; and
a service-oriented architecture operational management and monitoring governance dimension.

2. The method of claim 1, further comprising:
identifying and selecting a process within at least one of the governance dimensions applicable to the identified enterprise of concern;
applying the selected process against a stage of a service-oriented architecture business service lifecycle management component of the enterprise of concern; and
customizing and enabling a change management process and capability corresponding to the enterprise of concern.

3. The method of claim 2, further comprising defining a service-oriented architecture governance maturity roadmap for the enterprise of concern as a function of at least one of the identifying the gap, the identifying and selecting the enterprise of concern, the applying the selected process against the stage of the service-oriented architecture business service lifecycle management component, and the customizing and enabling the change management process and capability.

4. The method of claim 3 wherein the selected process is a process of the service-oriented architecture business and information technology alignment governance dimension selected from the group consisting of an enterprise program portfolio alignment process, a business services portfolio alignment process, a business services discovery process, a program and services prioritization process, a business case and planning process, a business process collaboration process, a business services identification process, a business and information technology change management process and a business services policy strategy and definition process.

5. The method of claim 3 wherein the selected process is a process of the service-oriented architecture ownership and decision rights governance dimension selected from the group consisting of a business services ownership process, a business services funding process, a domain classification and taxonomy process, a business services ownership change management process, a business services stakeholder management process and a business services policy ownership and stakeholder assignment process.

6. The method of claim 3 wherein the selected process is process of the service-oriented architecture asset lifecycle enablement and management governance dimension selected from the group consisting of a service discovery process, a service publishing process, an asset discovery process, an asset publishing process, an asset lifecycle change management process, a business services asset reuse management process, a business service process, an SOA standard process, a business services asset reuse program, an asset repository and registry process and a business services policy registry process.

7. The method of claim 3 wherein the selected process is process of the service-oriented architecture service operational management and monitoring governance dimension selected from the group consisting of a business services utilization and metering process, a business services performance monitoring process, an operational service change management process, a services provisioning process, a business services metrics measurement process, a services testing and certification process, a business services version management process and a business services policy enforcement and monitoring compliance process.

8. The method of claim 1, further comprising a service provider deploying at least one of the programmable device and the logic component.

9. The method of claim 8, further comprising the programmable device:
identifying and selecting a process within at least one of the service-oriented architecture governance dimensions applicable to the identified enterprise of concern;
applying the selected process against a stage of a service-oriented architecture business service lifecycle management component of the enterprise of concern; and
customizing and enabling a change management process and capability corresponding to the enterprise of concern.

10. The method of claim 9, further comprising the programmable device defining a service-oriented architecture governance maturity roadmap for the enterprise of concern as a function of at least one of the identifying the gap, the identifying and selecting the enterprise of concern, the applying the selected process against the stage of the service-oriented architecture business service lifecycle management component, and the customizing and enabling the change management process and capability.

11. The method of claim 10 wherein the selected process is a process of the service-oriented architecture business and information technology alignment dimension selected from the group consisting of an enterprise program portfolio alignment process, a business services portfolio alignment process, a business services discovery process, a program and services prioritization process, a business case and planning process, a business process collaboration process, a business services identification process, a business and information technology change management process and a business services policy strategy and definition process;
wherein the selected process is a process of the service-oriented architecture ownership and decision rights dimension selected from the group consisting of a business services ownership process, a business services funding process, a domain classification and taxonomy process, a business services ownership change management process, a business services stakeholder management process and a business services policy ownership and stakeholder assignment process;
wherein the selected process is process of the service-oriented architecture asset lifecycle enablement and management dimension selected from the group consisting of a service discovery process, a service publishing process, an asset discovery process, an asset publishing process, an asset lifecycle change management process, a business services asset reuse management process, a business service process, an SOA standard process, a business services asset reuse program, an asset repository and registry process and a business services policy registry process; or
wherein the selected process is process of the service-oriented architecture service operational management and monitoring dimension selected from the group consisting of a business services utilization and metering process, a business services performance monitoring process, an operational service change management process, a services provisioning process, a business services metrics measurement process, a services testing and certification process, a business services version management process and a business services policy enforcement and monitoring compliance process.

12. A method for implementing a service-oriented architecture governance framework, comprising:
producing computer executable program code;
storing the code on a computer readable medium; and
providing the program code to be deployed and executed on a computer system, the program code comprising instructions which, when executed on the computer system, cause the computer system to identify a gap within a service-oriented architecture service orientation enterprise of concern as a function of:
a service-oriented architecture business and information technology alignment governance dimension;
a service-oriented architecture ownership and decision rights governance dimension;
a service-oriented architecture asset lifecycle enablement and management governance dimension; and
a service-oriented architecture operational management and monitoring governance dimension.

13. The method of claim 12, the program code comprising instructions which, when executed on the computer system, further causes the computer system to:
identify and select a process within at least one of the service-oriented architecture governance dimensions applicable to the identified enterprise of concern;
apply the selected process against a stage of a service-oriented architecture business service lifecycle management component of the enterprise of concern; and
customize and enable a change management process and capability corresponding to the enterprise of concern.

14. The method of claim 13, the program code comprising instructions which, when executed on the computer system, further causes the computer system to defining a service-oriented architecture governance maturity roadmap for the enterprise of concern as a function of at least one of the identifying the gap, the identifying and selecting the enterprise of concern, the applying the selected process against the stage of the service-oriented architecture business service lifecycle management component, and the customizing and enabling the change management process and capability.

15. The method of claim 14 wherein the selected process is a process of the service-oriented architecture business and information technology alignment dimension selected from the group consisting of an enterprise program portfolio alignment process, a business services portfolio alignment process, a business services discovery process, a program and services prioritization process, a business case and planning process, a business process collaboration process, a business services identification process, a business and information technology change management process and a business services policy strategy and definition process;
wherein the selected process is a process of the service-oriented architecture ownership and decision rights dimension selected from the group consisting of a business services ownership process, a business services funding process, a domain classification and taxonomy process, a business services ownership change management process, a business services stakeholder management process and a business services policy ownership and stakeholder assignment process;
wherein the selected process is process of the service-oriented architecture asset lifecycle enablement and management dimension selected from the group consisting of a service discovery process, a service publishing process, an asset discovery process, an asset publishing process, an asset lifecycle change management process, a business services asset reuse management process, a business service process, an SOA standard process, a business services asset reuse program, an asset repository and registry process and a business services policy registry process; or
wherein the selected process is process of the service-oriented architecture service operational management and monitoring dimension selected from the group consisting of a business services utilization and metering process, a business services performance monitoring process, an operational service change management process, a services provisioning process, a business services metrics measurement process, a services testing and certification process, a business services version management process and a business services policy enforcement and monitoring compliance process.

16. A programmable device comprising:
a processing means;
a memory in communication with the processing means comprising a logic component; and
a network interface in communication with the processing means and the memory;
wherein the processing means is configured to identify a gap within a service-oriented architecture service orientation enterprise of concern as a function of:
a service-oriented architecture business and information technology alignment governance dimension;
a service-oriented architecture ownership and decision rights governance dimension;
a service-oriented architecture asset lifecycle enablement and management governance dimension; and
a service-oriented architecture operational management and monitoring governance dimension.

17. The programmable device of claim 16 wherein the processing means is further configured to:
identify and select a process within at least one of the service-oriented architecture governance dimensions applicable to the identified enterprise of concern;
apply the selected process against a stage of a service-oriented architecture business service lifecycle management component of the enterprise of concern; and
customize and enable a change management process and capability corresponding to the enterprise of concern.

18. The programmable device of claim 17 wherein the processing means is further configured to define a service-oriented architecture governance maturity roadmap for the enterprise of concern as a function of at least one of the identifying the gap, the identifying and selecting the enterprise of concern, the applying the selected process against the stage of the service-oriented architecture business service lifecycle management component, and the customizing and enabling the change management process and capability.

19. The programmable device of claim 18 wherein the selected process is a process of the service-oriented architecture business and information technology alignment dimension selected from the group consisting of an enterprise program portfolio alignment process, a business services portfolio alignment process, a business services discovery process, a program and services prioritization process, a business case and planning process, a business process collaboration process, a business services identification process, a business and information technology change management process and a business services policy strategy and definition process;
wherein the selected process is a process of the service-oriented architecture ownership and decision rights dimension selected from the group consisting of a business services ownership process, a business services funding process, a domain classification and taxonomy process, a business services ownership change management process, a business services stakeholder management process and a business services policy ownership and stakeholder assignment process;
wherein the selected process is process of the service-oriented architecture asset lifecycle enablement and management dimension selected from the group consisting of a service discovery process, a service publishing process, an asset discovery process, an asset publishing process, an asset lifecycle change management process, a business services asset reuse management process, a business service process, an SOA standard process, a business services asset reuse program, an asset repository and registry process and a business services policy registry process; or
wherein the selected process is process of the service-oriented architecture service operational management and monitoring dimension selected from the group consisting of a business services utilization and metering process, a business services performance monitoring process, an operational service change management process, a services provisioning process, a business services metrics measurement process, a services testing and certification process, a business services version management process and a business services policy enforcement and monitoring compliance process.
